(19) United States
(12) Patent Application Publication
(10) Pub. No.: US 2010/0036726 A1
(43) Pub. Date: Feb. 11, 2010

(54) METHOD OF REDUCING COST PER ACTION OF AN INTERNET ADVERTISEMENT CAMPAIGN, AND OPTIMIZING TO THE MAXIMUM THE NUMBER OF ACTIONS PERFORMED BY WEB SURFERS

(75) Inventor: Bernard Gallet, Los Altos, CA (US)

Correspondence Address: FULBRIGHT & JAWORSKI, LLP, 666 FIFTH AVE, NEW YORK, NY, 10103-3198, US

(73) Assignee: REFERENCEMENT.COM France

(21) Appl. No.: 12/309,098

(22) PCT Filed: Jul. 6, 2007
(86) PCT No.: PCT/FR2007/001162

§ 371 Date: Sep. 23, 2009

Related U.S. Application Data
(60) Provisional application No. 60/806,717, filed on Jul. 6, 2006.

(51) Int. Cl. G06Q 30/00; G06Q 10/00; G06F 17/30

(52) U.S. Cl. 705/14.43; 705/14.45; 705/14.48; 707/104.1; 707/E17.044

(57) ABSTRACT

The invention concerns a cost-reduction method per action performed during an online interactive advertising campaign. The method implements the following steps:
the cost of each keyword in the campaign is revalued (12),
positive keywords are generated (16),
negative keywords are generated (17),
   automatic performance tests (20) of the advertising campaign are conducted,
the best messages (19) of the campaign are generated,
the advertising campaign is sent to the Search Engine Media.

### FIELD OF THE INVENTION

The purpose of the present invention is to reduce costs per action for an advertising campaign, based on the media of online search engines and enabling to maximise the number of actions performed by internauts. The present invention finds especially advantageous applications, albeit not exclusive, in the field of online internet advertising.

### STATE OF THE ART

Currently, in the state of the Art, when an advertiser creates an online advertising campaign to sell goods or propose a service offer, such advertiser has to determine a series of attractive messages for each advertisement of its campaign in order for internauts or internet users to be able to perform actions on its advertisements. Each of these messages is associated with a series of keywords.

When an internaut launches a query in a search engine (Google, Yahoo, Voilà, Msn, etc.) using one of the keywords or a combination of keywords, the search engine directs to a series of so-called “natural” links. These natural links correspond to web pages classified according to their relevant pertinence. In addition to these natural links, the search engine directs to so-called “sponsored” links. These sponsored links are commercial links leading to web pages of a publicity campaign.

In order to increase the number of internauts on the commercial web pages, an indexing system exists for the sponsored links in order to improve their visibility.

This indexing system is based on an auction system applied to a maximum price awarded to each keyword. Indeed, an advertiser may enable the maximum price of each keyword in its advertising campaign to vary for the purpose of modifying the position of its advertisements in order to obtain, for example, more clicks or actions from internauts, though at little cost.

In order to improve the efficiency of such optimisation, it is not uncommon to produce negative keywords, Such keywords are employed by the Search Engine Media. These negative keywords enable search engines not to provoke an advertisement impression. A good choice of negative keywords thus enables to find the most successful keywords, not only in order to increase the number of clicks by internauts via the click-through-rate (commonly called “CTR”, which corresponds to the number of clicks divided by the number of impressions), but also to increase the pertinence of the campaign or even the conversion rate of the campaign. The good choice of negative keywords thus enables to increase the level of the campaign's indexing if the search engine's sales supplier uses a performance-based system for advertisements.

Nevertheless, this type of campaign optimisation comprises certain drawbacks. Indeed, currently, when an advertiser creates an online product sales campaign, it is confronted with visibility problems for its campaign. This visibility problem is due to increased competition within the corresponding field or to a broader diversity of the products being sold. In order to obtain enhanced visibility and a good sales result, the advertiser is thus obliged to initiate better optimisation of its campaign.

### OBJECT OF THE INVENTION

The present invention is aimed at solving the various problems described above. In order to do so, the invention proposes a cost-reduction method per action (or purchase) in a search engine sales campaign, while fully optimising the number of actions performed by internauts. Hence, the purpose of the invention is to propose slight corrections in order to improve the advertising campaigns, thereby reducing the cost involved for an advertiser for every click or conversion (or action) during a campaign, while maximising the number of conversions (or actions). This results in an optimisation (or reduction) of the CPA (cost per action).

One aim of the invention is to reduce the cost per action. In order to do so, the invention concerns a cost-revaluation method for each keyword in an online advertising campaign, characterised in that it comprises the following steps:

a series of keywords, not used by internauts during an advertising campaign, is determined,

a cost per thousand impressions is determined, corresponding to the purchase cost of the advertising space on a Website, calculated by series of thousand impressions or pages viewed,

the position of each keyword is revaluated according to the series of unused keywords and to the cost per thousand impressions, for the purpose of reducing the advertising campaign's daily budget,

a new price is determined for each keyword in the advertising campaign, depending on their revaluated position and on their previous cost.

The invention may also comprise one or several of the following characteristics:

a keyword/price/advertisement combination is determined for each given day,

a percentage of the daily budget used by the Search Engine Media for displaying advertisements is determined, depending on the keyword/price/advertisement combination,

if the percentage of the daily budget used by the Search Engine Media is below 95%, the maximum price for each keyword of the campaign is increased in order to improve the advertisements' position,

if the percentage of the daily budget used by the Search Engine Media exceeds 99%, the maximum price for each keyword of the campaign is reduced in order to return to a lower price level,

determination of the cost per thousand impressions is only converted into payment if the clicks or actions are performed by internauts,

revaluation of the indexing of each keyword comprises the following steps:
a cost per action is determined, an action notably corresponding to a sales transaction, a customer purchase or a simple click,
the cost per action is divided by the cost per thousand,
each keyword is awarded the result of the corresponding division,
the keywords of the advertising campaign are classified according to the result awarded to each keyword,
a weight is allocated to each position of every keyword depending on their classification,

determination of the new price for the keywords of the advertising campaign for the purpose of reducing daily costs comprises the following steps:

for each keyword is determined a price, depending on their rank and on their weight,

for each keyword, the said price is subtracted from the previous price of the keyword,

if the difference is negative, the keywords are awarded their previous price; otherwise they are awarded the corresponding determined price,

the keywords produced, whose new price is equal to the maximum price of equivalent keywords, are evaluated,

a list of the search queries made by internauts is compiled for each search engine,

a price is awarded to each existing keyword depending on the number of searches made using said keyword, on the number of words in this keyword and on the scope of said keyword,

Another aim of the invention is to generate new successful keywords; in order to do so, the invention concerns a method for generating new keywords in an online advertising campaign, characterised in that it comprises the following steps:

new combined keywords are generated based on keywords included in a list of keywords of the existing campaign,

this list of new combined keywords is recorded in a database,

new wrongly-spelt keywords are generated based on keywords included in the list of keywords of the existing campaign,

this list of new wrongly-spelt keywords is recorded in the database,

a frequency rate is determined for each new combined and/or wrongly-spelt keyword over the Internet,

a potential list of the most successful new keywords is generated,

The invention may also comprise one or several of the following characteristics:

new combined keywords are generated by all possible permutations of keywords included in the list of keywords of the existing campaign,

new combined keywords are generated via a two-by-two combination of keywords,

in order to generate new combined keywords, the most successful keywords are selected from the list of keywords of the existing campaign,

new wrongly-spelt keywords are generated by modifying, letter-by-letter, the keywords included in the list of keywords of the existing campaign,

letter-by-letter modification is achieved by using, for each letter of the keywords included in the list of keywords of the existing campaign, the neighbouring letters on a computer keyboard,

the new wrongly-spelt keywords comprising at least one duplicate letter are deleted.

determination of the frequency of use of each new keyword online comprises the following steps:
the usage frequency of a keyword online is calculated by searching for the said keyword in all languages, one-by-one over the Internet, passing through the same paths as a search engine,
based on such search, a list of keywords is generated in accordance with their language and with their frequency rates,
this list of keywords (word/language/frequency) is recorded in the database,

generation of the list of potential new keywords comprises the following steps:
a)—a list of new potential keywords is generated based on a campaign's URL,
b)—based on this list of potential new keywords, the page of the advertising campaign is downloaded and three lists of keywords are generated,
   a first list being a list of meta-keywords corresponding to the keywords that the page designer considers as being representative of such page,
   a second list being the list of keywords included in this page, as well as their automatic counting,
   a third list being the list of all the URL links of this page,

for each URL link obtained on the third list, steps a) and b) are applied,

the selection of the most successful keywords comprises the following steps,
c)—an analysis of the relative frequency of the keywords is performed using the database (word/language/frequency),
d)—the most representative of these keywords is selected by performing combinations in order to find synonymous keywords,
   for each synonymous keyword, steps c) and d) are applied,
   the resulting list is recorded and arranged for insertion into test campaigns,

Another aim of the invention is to establish a list of negative keywords in order to improve the campaign's visibility. In order to do so, the invention concerns a method for generating negative keywords in an advertising campaign, characterised in that it comprises the following steps:

all keywords of the search queries made by internauts on search engines are retrieved,

this list of keywords of every search query is compared with a list of keywords of an existing advertising campaign,

a list of negative keywords comprising search query keywords not included in the list of keywords of the existing campaign is automatically created,

this list of negative keywords is recorded in a database.

The invention may also comprise one or several of the following characteristics:

all search query keywords are retrieved through the intermediary of the search engines' application programme interfaces, or APIs,

generation of search query keywords comprises the following steps,
each search query is separated into a list of individual keywords,
such separation is repeated for each keyword on the list,
this list of search query keywords is recorded in a database.

comparison of the search query keywords with the list of keywords of the existing campaign comprises the following steps:

a neighbouring search query keyword is compared with the list of keywords of the existing campaign,

if a search query keyword is included in the list of keywords of the existing campaign,
the keyword used during the campaign is checked as to whether it is contained in the search query, and
if the said keyword is contained in the search query, the keyword used in the list of negative keywords is added,

the search query keywords are checked as to whether they have all been processed,

Another aim of the invention is to test the different advertisements in the campaign in order to minimise the negative effects of the direct launch of the campaign online. In order to do so, the invention concerns an automatic performance testing method of a main advertising campaign, characterised in that it comprises the following steps:

three new groups of secondary advertisements are automatically created in order to test the performances of already-created advertisements,

The invention may also comprise one or several of the following characteristics:

the first group of advertisements created comprises exactly the same data as the advertising campaign and is used as a test bench for new keywords,

the second group of advertisements created comprises exactly the same data as the advertising campaign and is used as a test bench for new advertising messages,

the third group of advertisements created comprises exactly the same data as the advertising campaign and is used as a test bench for negative keywords,

each of these advertising groups is allocated the same data as that for the advertising campaign, such data notably being the submission price proposed for a keyword, the same message, the same negative keywords, the same cash price,

test results for the first, second and third advertisement groups are respectively retrieved,

the three advertisement groups created are automatically deactivated as soon as sufficient data is retrieved for analysis,

the test results are analysed in order to determine the most efficient group of advertisements in relation to the advertising campaign,

Another aim of the invention is to generate the best possible message in order to have a better conversion rate. In order to do so, the invention concerns a method for generating messages in an advertising campaign, characterised in that it comprises the following steps:

new messages are acquired,

the best message among the messages acquired is determined according to its click in relation to a click-through-rate or CTR, such rate being obtained by dividing the number of internauts having clicked on the advertisement of a web page by the number of times the advertisement has been delivered,

The invention may also comprise one or several of the following characteristics:

determination of the best messages comprises the following steps:

each message of an advertising campaign is divided into sentences,

each sentence is automatically combined one with another in order to create new messages,

the new messages are tested in order to select the best messages,

a database of messages is determined,

the best messages are recorded in the database,

each message in the database is associated with a series of keywords,

each message in the database is compared with each sentence of the existing messages,

every sentence of the existing messages is added to all messages available in the database, insofar as a correspondence exists between a sentence and a message,

a database of synonyms is determined,

a database comprising slogans is determined,

each slogan is associated with a series of keywords,

this database of slogans is compared with the sentences of the existing messages,

a new sentence is constructed using the synonyms of the associated keywords, insofar as a correspondence exists between the database of slogans and the sentences of existing messages,

the new sentence is added to all available messages.

Another aim of the invention is to be able to send all data of the advertising campaign to several online Search Engine Media. In order to do so, the invention concerns a method for sending an advertising campaign onto the Search Engine Media, characterised in that it comprises the following steps:

each advertiser's campaign administrator account is approved for each Search Engine Media,

at least one advertising campaign is automatically sent to each Search Engine Media,

Advantageously, another aim of the invention is to fully optimise an advertising campaign by reducing the cost per action. In order to do so, the invention concerns a cost-reduction method per action performed during an online advertising campaign, characterised in that it implements the following steps according to any one of the previous characteristics:

each keyword is revalued,

positive keywords are generated,

negative keywords are generated,

the groups of advertisements undergo automatic testing,

messages are generated,

a single advertising campaign is sent to the Search Engine Media.

### BRIEF DESCRIPTION OF THE FIGURES

The invention will be better understood after reading the description that follows and after studying the figures attached hereto. These are shown as examples only and are not to be considered as complete with regard to the invention.

FIG. 1 illustrates the interaction of the various parts, having the aim to implement the different algorithms of the invention,

FIG. 2 is a functional diagram of the invention's method for producing a list of negative keywords using a list of URLs and a list of positive keywords at the outset;

FIG. 3 is a flow chart illustrating a negative keyword generator;

### DETAILED DESCRIPTION OF THE INVENTION'S EMBODIMENT

Each advertiser has a user account with a login and a password enabling it to open a negotiation session on a computer by being authenticated on a server. The advertiser has a personal address book located in a database connected to at least one server, wherein is stored the digital data concerning its advertising campaign and to which it is automatically connected once its session has been opened. Such data being centralised using at least one server, the advertiser may have access to the data via any computer linked to the internet network. Such server comprises a processor capable of implementing the invention's method.

The server communicates respectively with the various servers of the internet search tools or engines through the intermediary of several Application Programme Interfaces. These Application Programme Interfaces are better known as APIs. These APIs enable to interact with the relational databases via queries. These APIs enable to connect to the respective databases of each search tool or engine in almost all transparency.

The server hosing an advertiser account is connected to each search tool or engine through the direct intermediary of the API. Once connected, the server downloads the events having occurred according to the campaign criteria, in order to obtain a working basis.

Three types of campaign criteria are distinguished. The first criterion concerns the advertiser and comprises the contents of an advert, a selection of keywords associated to an auction system and a daily budget that must be spent. The second criterion concerns the Search Engine Media, better known under the abbreviation “SEM”, comprising advertisement pertinence, the number of impressions for the advert, advertisement indexing and the rules for bidding, in addition to a balance between the keyword, the advertisement and the page on which the internaut is redirected (namely, the “landing page”). The third criterion concerns the internaut or the search engine user, the number of clicks on an advertisement and the number of converted clicks. By “conversion” is meant an online purchase or online registration by an internaut or internet user, or even any other measurable target, such as defined by the advertiser.

The invention comprises several algorithms capable of processing the data collected, while dynamically altering the criteria.

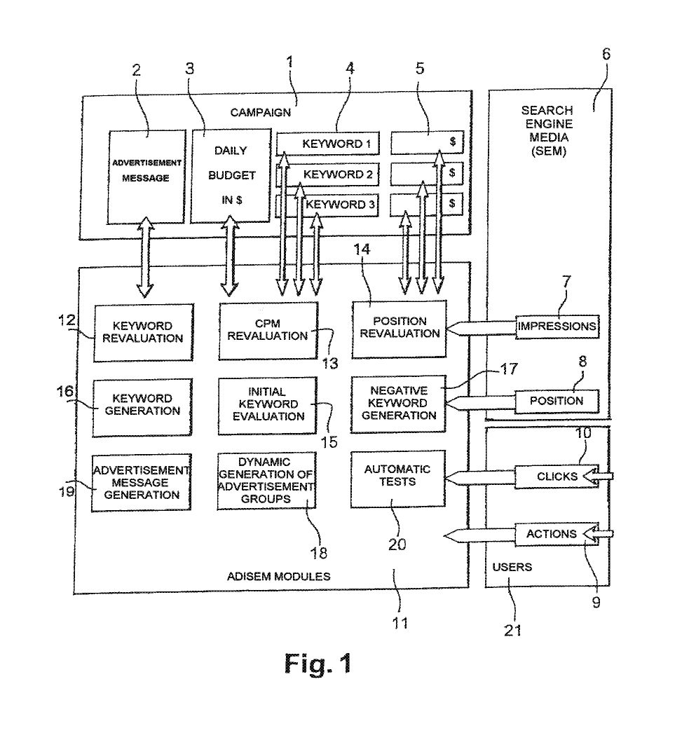

FIG. 1 illustrates the interaction of the various parts, having the aim to implement the different algorithms of the invention. The example proposed in FIG. 1 illustrates a first part concerning an advertiser connected to its account in order to create an advertising campaign 1. This advertising campaign 1 comprises an advertising message 2 that is none other than the literal contents of the advertisement. It also comprises a daily budget 3, necessary for bidding on the keywords with each Search Engine Media (Google Adwords, MSN AdCenter, etc.). The advertising campaign 1 comprises keywords 4 associated with their maximum unit price 5 in order to serve as a basis for bidding.

A second part concerns the Search Engine Media 6 for each search engine that manages advertisement impressions 7. These impressions 7 represent the display of these campaigns when a query of at least one keyword 4 is made on a search engine. The Search Engine Media 6 also manages the position or indexing 8 of the advertisement in accordance with the amount allocated by the advertisers for bidding on the maximum prices of keywords 4, in addition to other factors simply concerning the search engines.

The third part concerns the user or the internauts who are prompted to perform actions 9 (purchase, online registration, etc.) or clicks 10 that are automatically counted by each Search Engine Media 6 before being transmitted to a fourth part, namely a digital data processing platform 11. This platform 11 receives not only data to be processed (impressions 7, position 8, actions 9, clicks 10, etc.) through the intermediary of the APIs of each search engine, but also data supplied by the advertiser whilst managing its campaign. The platform 11 is a software platform comprising several algorithms having the aim to collect data concerning the advertiser and the search engines, in order to process them to enable the advertiser to optimise its advertising campaign and to have better results in terms of the sale of goods or services. This platform 11 is located on the server to which the advertiser is connected.

The invention implements a first algorithm 12 enabling an automatic revaluation of the keywords 4 with the aim of lowering the cost per action, more commonly known as “CPA”. An action may concern a sales transaction, a customer purchase or a simple click. It is also called “cost by transaction”. The CPA may also refer to the cost per purchase.

Each keyword passes through various rules in a sequential order. Each rule is an occasion to change the price 5 of the maximum bidding submission for keywords 4. Indeed, the volume of the unused traffic is determined. The aim of this algorithm 12 is to use the advertiser's total daily budget to a full.

Indeed, it is necessary to have a keyword/price/advertisement combination, and this for any given day. The Search Engine Media could be in a position to deliver between 95% and 105% of this daily budget 3. If this ratio falls below 95%, the algorithm 12 will aim to increase the costs or the maximum price of each keyword, i.e. improve the position 8 or the indexing of the advertisements of the campaign 1 in order to fully use the daily budget 3. If the algorithm 12 exceeds 99% of the daily budget 3, it reduces the price 5 in order to return to a lower price level. At this point, the algorithm 12 negotiates the indexing of the maximum price 5 for each keyword.

The invention implements an algorithm 13 that aims at determining a cost per thousand impressions, more commonly known as “CPM”, that is as high as possible. Although on the one hand, the CPM is only obtained via the inventories of the impressions 7, such CPM may only be converted into payment if the clicks 10 are actually performed by the internauts, on the other.

The CPM is a purchase cost of an advertising space on a Website, calculated per 1000 impressions or pages viewed, i.e. depending on the number of times a banner or other advertising element is displayed. The invoicing unit for an online advertising campaign is the CPM (cost per thousand displays), which of course varies depending on the type of display. Let us say, for example, that the price of the banner adverts is estimated at a cost per thousand. This indicator enables to evaluate and to compare the advertising rates for the different Websites in accordance with the number of pages containing publicity having been viewed.

Moreover, the aim of the advertiser is to reduce the CPA as much as possible. For each keyword 4, the algorithm 13 divides the CPA by the CPM. Then the algorithm 13 awards the result of the corresponding division to each keyword 4. Finally, the algorithm 13 classifies the said keywords in the advertising campaign 1 according to the result awarded to each keyword 4.

The higher the CPM is in relation to the CPA, the better the rating of such keyword 4 for the advertiser and for the Search Engine Media 6. Similarly, the higher a keyword 4 in the rating, the less favourable it is for both parties. When the keywords 4 are classified, the algorithm 13 awards a price in accordance with the rating. The keywords 4 having a poor rating see their prices reduced. The algorithm 13 also allocates a weight to the current position with the aim of standardising the CPM data, being understood that the click rates (click per impression) are of course higher when in the upper positions.

The invention implements an indexing 8 (or position) revaluation algorithm 14 for each keyword in order to enable a reduction in the expenditure of the daily budget 3. In order to do so, this algorithm 14 awards a new price to the keywords 4 having the best indexing 8 in the campaign 1. This new price is reduced in relation to their previous price. This newly-awarded price is a percentage of the real cost per click, more commonly known as “CPC”, for these keywords 4. If this campaign 1 is based on the “actions”, the CPA is then used instead of the CPC.

The invention implements an algorithm 15 capable of calculating the initial price of a keyword 4 for an existing campaign 1. The algorithm 15 enables to determine the best initial price of a newly-produced keyword. In order to so, the algorithm 15 evaluates the newly-produced keyword as being equal to the maximum price of equivalent keywords in an existing campaign. The algorithm 15 conducts a search into past predefined research data and selects the price of the said existing keyword. Such research data may be supplied by an external source, for example the Search Engine Media of every search engine.

The algorithm 15 calculates the price awarded to the existing keywords according to the following parameters:

the number of searches made using this keyword,

the number of words in this keyword,

the scope of this keyword (i.e. broad, exact or in sentences).

The invention implements an algorithm 16 capable of generating combined keywords. The aim of this algorithm 16 is to produce new keyword combinations. This algorithm 16 uses the most successful keywords of an existing campaign 1 and generates all possible combinations. Such combinations are obtained via the permutations and the two-by-two combinations of the keywords.

For example, if the most successful keywords are “car” and “energy”, then the following keywords generated by the algorithm 16 are:

“car energy”,

“energy car”,

car energy,

[car energy],

[energy car].

The inverted commas correspond to the sentences wherein the words must be considered in their same order. The square brackets correspond to an exact usage of the words by the internaut or the internet user, with no intermediary words.

The algorithm 16 generates wrongly-spelt keywords. Such algorithm uses the most successful keywords of an existing campaign 1 and generates new keywords. These new keywords are obtained by modifying the said keywords. Such modification of the keywords is achieved letter-by-letter, using the neighbouring letters on a computer keyboard for each of the letters. This algorithm 16 thus enables to delete duplicate letters, such as two “m” in the word “immediate”.

The algorithm 16 is capable of calculating the online usage rate of a word. For every language, this algorithm seeks, step-by-step, the same online paths as those of a search engine. Then it generates a list of words with their frequency rate. This information (word/language/frequency) is then recorded in a database (word/language/frequency) of the server. This database (word/language/frequency) may be reused by other algorithms of the invention.

The algorithm 16 is capable of generating a list of potential new keywords. The algorithm 16 is initiated based on the URL of the existing advertising campaign. Then it downloads the page and generates three lists of keywords.

The first list is a list of meta-keywords. These meta-keywords are the keywords that the web page designer considers as being the most representative of such page.

The second list is a list of words included in this page, as well as their automatic counting.

The third list is a list of all the links on this page. The algorithm 16 repeats this process for all the URLs included in the third list. This process is repeated recursively as necessary.

The algorithm 16 analyses the relative frequency of the said keywords by using the previously-created database (word/language/frequency) and selects the most representative of the keywords. These keywords are then searched in combination in order to find the synonymous keywords, and the process is repeated for such synonyms. The resulting list of keywords is then recorded and arranged for insertion into test campaigns, for example performed by an automatic testing algorithm 20.

The invention implements an algorithm 17 having the purpose of generating negative keywords. This algorithm 17 retrieves a list of all keyword queries searched by internauts 21 or internet users over a certain period, for example during the month preceding such retrieval through the intermediary of the search engine's APIs, the APIs being programme interfaces. Such algorithm 17 compares this retrieved list to a list of keywords generated by the keyword-generating algorithm. An automatic creation of negative keywords is performed for keywords not included in the list of generated keywords. Each one of the lists is included in the searches having at least one keyword associated with the generated list. This list, arranged according to the considered search, is recorded in a database for future insertion into test campaigns performed by the automatic testing algorithm 20.

The invention implements an automatic testing algorithm 20 that automatically creates new groups of advertisements, also called “secondary campaigns”, having the aim to test the performances of already-created advertisements. The original campaign 1 (existing campaign) remains the main campaign. The first group of additional advertisements is used as a bench test for new keywords. The second group of additional advertisements is used as a bench test for new messages. The third group of additional advertisements is used as a bench test for negative keywords.

These three new groups of advertisements employ the three most efficient keyword interpretations of the main advertising campaign. In each of these groups of advertisements, all data is exactly the same as that of the main campaign. In other words, the same proposed bidding price, the same message, the same negative keywords and the same cash price (daily budget) are noted, with the exception of sectors undergoing testing. The method of the invention provides these advertisement groups with the necessary time for obtaining the appropriate data in terms of statistics. When sufficient data has been collected, these groups of advertisements are automatically deactivated. During the next calculation round, these results are analysed in order to determine which test campaign (secondary) is the most efficient in relation to the current main campaign.

The invention implements an algorithm 19 enabling to generate the best possible message. By “best message” is meant a message that produces a better click via the click-through-rate, more commonly known as “CTR”, and thus a better conversion rate (purchases, registrations, etc.). The CTR is obtained by dividing the number of internauts having clicked on the advertisement of a web page by the number of times the advertisement has been delivered. Such index enables advertising campaigns to be more efficient, and improves the results of search engines.

In order to do so, the advertiser's messages are divided into sentences. These sentences are thus automatically combined in order to create new messages. These messages are then sent towards the test algorithm 20 in order to select the best ones. A database of publicity slogans or catch-phrases is defined. Each publicity slogan is associated with a series of keywords. This database is compared with the groups of words in the existing messages. When a comparison is terminated, this sentence is added to all available messages. The process is then repeated by using the campaign's redirected web page.

As soon as the advertiser has approved all the data in its campaign-advertiser accounts for at least one Search Engine Media, a final algorithm automatically sends the advertising campaigns across multiple Search Engine Media in order to have the best return on investment, commonly known as “ROI”.

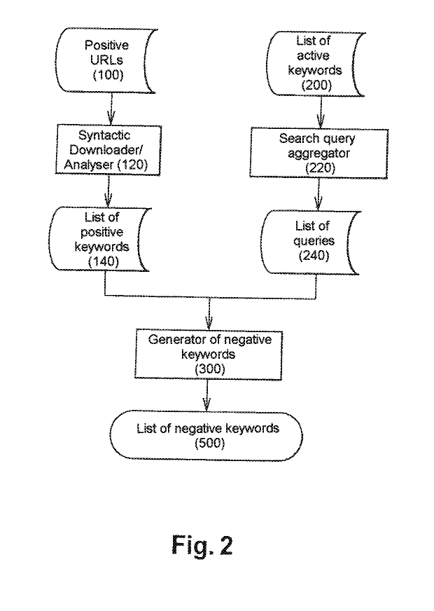

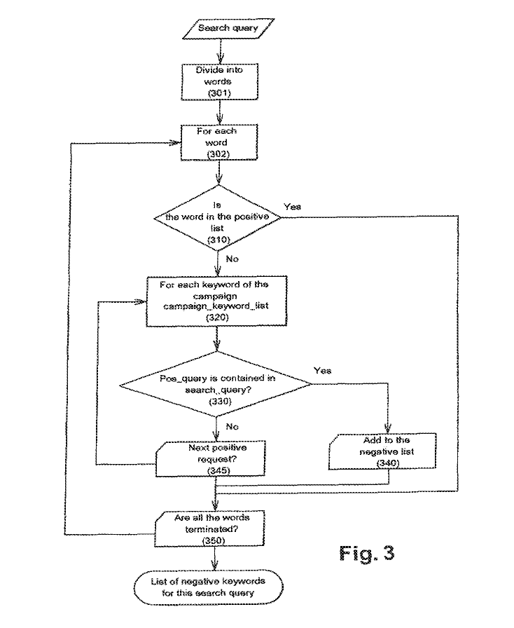

FIG. 2 and FIG. 3 illustrate an example of sequential steps for implementing the negative keyword generator.

FIG. 2 illustrates an algorithm 120 which downloads and analyses a list of positive URLs 100. In an embodiment of the invention, this list of positive URLs is automatically extracted from the original campaign, namely the campaign for which the advertiser wishes to produce negative keywords. In another embodiment, this list of URLs is generated by conducting searches on different search engines using some or all of the keywords on the list of the campaign's keywords. For each URL of the list of positive URLs, the page is downloaded, analysed and then split into words. This list of words is then concatenated to the list of keywords of the campaign in order to create the list of positive keywords.

Another system 220 generates a list of user queries performed on a search engine for each one of the keywords included in the list of keywords of the campaign. In an embodiment of the invention, this list is generated using “an API of relative suggestions” by the online search engines, namely “Yahoo” or even “Google”. Unionised search queries generate a list of search queries 240 to be used by the negative-keyword generator 300 at the same time as the list of positive keywords 140.

FIG. 3 is a flow chart illustrating a negative keyword generator. In the example in FIG. 3, the following data has been used:
keywords_campaign (step 200): [‘Ads’, ‘TV Ads’, ‘commercials’, ‘advertising specialty’]
positive-keywords (step 140): [‘Ads’, ‘TV’, ‘commercials’ ]
user_queries (step 240): [‘Ads’, ‘personal ads’, ‘nickel ads’, ‘specialty store’]

In step 301, a search query produced by the question generator 220 is split into a list of individual words. Hence, the search query “personal ads” is separated into a list of two words, “personal” and “ads”.

The step 302 is reiterated for each word in this list. The word is thus compared with the positive list obtained in step 310. If it is included in the positive list, the programme continues with the next word in the search query.

If the word is not included in the positive keywords (i.e. “personal”, “nickel” or “store” in our example), the step 320 is performed as a loop in the list of keywords of the campaign.

In step 300, the keyword used during the campaign is checked as to whether it is completely contained in the search query. For example, the search query “nickel ads” contains the word “ads”. However, the query “specialty store” contains none of the keywords in the above example.

If the keyword is contained in the current search query, then this keyword is added as a negative keyword. The approval step 330 is applied to the next word in the search query. Otherwise, the search continues across the list of keywords in the campaign.

In step 350, it is checked whether all the words in the list of keywords of the campaign have been processed. If all these words are processed, the algorithm supplies at output a negative list of keywords generated for this query.

In another embodiment of the invention, for each search query, the number of searches made during a given period are collected for each one. The number of impressions generated using our list of keywords during the same period is thus known. The number of searches and the number of impressions are used in order to classify the negative keyword produced in terms of importance. It is possible to deduct the generation effect of these negative keywords by comparing the number of impressions before and after using these negative keywords. Such comparison may be used for the purpose of refining the result.

1-35. (canceled)

36. A cost-revaluation method for each keyword of an online advertising campaign, comprising the steps of:
determining a series of keywords, not used by internauts, during said online advertising campaign by a keyword revaluator of a data processing server;
calculating a cost per thousand impressions (CPM) corresponding to a purchase cost of an advertising space on a Website by a CPM revaluator of said data processing server based on impression data received from a search engine medium over a communications network, said impression data being related series of thousand impressions or pages viewed by the internauts, and captured by said search engine medium;
revaluating a position of each keyword in accordance with all unused keywords and the cost per thousand impressions to reduce a daily budget of said online advertising campaign by a position revaluator of said data processing server using position data received from said search engine medium over said communications network; and
determining and storing a new price for each keyword in said online advertising campaign based on the revaluated position and a previous price of said each keyword in a database by said position revaluator of said data processing server, thereby reducing a daily cost of said online advertising campaign.

37. The method of claim 36, further comprising the steps of:
determining and storing a keyword/price/advertisement combination for each given day in said database by said keyword revaluator of said data processing server; and
determining a percentage of the daily budget used by a Search Engine Media for displaying advertisements in accordance with the keyword/price/advertisement combination in said database by said keyword revaluator of said data processing server.

38. The method of claim 37, further comprising the step of increasing and storing a maximum price for said each keyword of said online advertising campaign to improve a position of advertisements in said database by said keyword revaluator of said data processing server if the percentage of the daily budget used by the Search Engine Media is below 95%.

39. The method of claim 37, further comprising the step of decreasing and storing a maximum price for said each keyword of said online advertising campaign to return to a lower price level in said database by said keyword revaluator of said data processing server if the percentage of the daily budget used by the Search Engine Media exceeds 99%.

40. The method of claim 36, further comprising the step of converting the cost per thousand impressions into payment by an advertiser of said online advertising campaign if clicks or actions are actually performed by the internauts as determined by said search engine medium.

41. The method of claim 36, wherein the step of revaluating the position of said each keyword comprises the steps of:
determining and storing a cost per action in said database by said CPM revaluator of said data processing server based on actions data and clicks data captured by and received from said search engine medium, said action corresponding to a sales transaction, a customer purchase or a simple click;
dividing the cost per action by the cost per thousand to provide a division result by said CPM revaluator of said data processing server;
awarding a corresponding division result to said each keyword by said CPM revaluator of said data processing server;
classifying said each keyword of said online advertising campaign in accordance with said corresponding division result awarded to said each keyword by said CPM revaluator of said data processing server; and
allocating a weight to each position of every keyword of said online advertising campaign based on a classification or rating of said each keyword by said CPM revaluator of said data processing server.

42. The method of claim 41, wherein the step of determining the new price for said each keyword of said online advertising campaign, comprises the steps of:
determining a price for said each keyword based on said classification of said each keyword and said weight of said each keyword by said position revaluator of said data processing server;
subtracting said price of said each keyword from said previous price of said each keyword to provide a difference by position revaluator of said data processing server; and
assigning and storing said previous price of said each keyword as said new price of said each keyword in said database by said position revaluator of said data processing server if said difference for said each keyword is negative and otherwise assigning and storing said price of said each keyword as said new price of said each keyword in said database by said position revaluator of said data processing server.

43. The method of claim 36, further comprising the steps of:
evaluating said each keyword with the new price equal to a maximum price of an equivalent keyword by an initial keyword evaluator of said data processing server;
compiling a list of the search queries performed by said internauts for each search engine by said initial keyword evaluator of said data processing server; and
assigning a price to each existing keyword based on a number of searches made using said each existing keyword, a number of words contained in said each existing keyword and a scope of said each existing keyword by said initial keyword evaluator of said data processing server.

44. The method of claim 36, further comprising the step of transmitting said online advertising campaign onto said search engine medium by approving each advertiser's campaign administrator account for said search engine medium by said data processing server, and automatically transmitting at least one advertising campaign received from an advertiser computer over said communications network to said search engine medium by said data processing server.

45. The method of claim 36, further comprising the step of performing the cost-revaluation during a search engine sales campaign by said data processing server.

46. A method for generating new keywords for an existing online advertising campaign, comprising the steps of:
generating a list of new combined keywords based on keywords in a list of keywords of said existing online advertising campaign by a keyword generator of a data processing server;
storing said list of new combined keywords in a database by said keyword generator of said data processing server;
generating a list of new wrongly-spelt keywords on the keywords in said list of keywords of said existing online advertising campaign by said keyword generator of said data processing server;
storing said list of new wrongly-spelt keywords in said database by said keyword generator of said data processing server;
determining an usage frequency rate for at least one of the following: each new combined keyword in said list of new combined keywords or each new wrongly-spelt keyword in said list of new wrongly-spelt keywords by said keyword generator of said data processing server; and
generating and storing a list of a potentially successful new keywords based on said frequency rate in said database by said keyword generator of said data processing server.

47. The method of claim 46, further comprising the step of generating said new combined keywords based on possible permutations of the keywords in said list of keywords of said existing online advertising campaign by said keyword generator of said data processing server.

48. The method of claim 46, further comprising the step of generating said new combined keywords via a two-by-two combination of the keywords in said list of keywords of said existing online advertising campaign by said keyword generator of said data processing server.

49. The method of claim 46, further comprising the step of generating said new combined keywords by selecting successful keywords from said list of keywords of said existing online advertising campaign by said keyword generator of said data processing server.

50. The method of claim 46, further comprising the step of generating said new wrongly-spelt keywords by modifying, letter-by-letter, the keywords in said list of keywords of said existing online advertising campaign by said keyword generator of said data processing server.

51. The method of claim 50, further comprising the step of modifying each letter of a keyword in said list of keywords of said existing online advertising campaign with neighbouring letters on a computer keyboard to provide a letter-by-letter modification of the keywords by said keyword generator of said data processing server.

52. The method of claim 51, further comprising the step of deleting a new wrongly-spelt keyword comprising at least one duplicate letter by said keyword generator of said data processing server.

53. The method of claim 49, further comprising the step of determining an usage frequency rate of a new online keyword by:
calculating said usage frequency rate of said new online keyword by searching for new online keywords in a plurality of languages, one-by-one over the Internet by said keyword generator of said data processing server, passing through same paths as a search engine;
generating a list of potential new keywords based on search for said new online keywords in accordance with language and said usage frequency rates of said new online keywords by said keyword generator of said data processing server; and
storing said list of potential new keywords, and said language and said usage frequency rate associated with each potential new keyword in said list of potential keywords in said database by said keyword generator of said data processing server.

54. The method of claim 53, wherein the step of generating said list of potential new keywords comprises the steps of:
generating said list of potential new keywords based on an uniform resource locator (URL) of said existing online advertising campaign by said keyword generator of said data processing server; and
downloading a page said existing online advertising campaign based on said list of potential new keywords and generating three lists of keywords by said keyword generator of said data processing server, said three lists of keywords comprising:
a list of meta-keywords corresponding to said potential new keywords as being representative of the page;
a list of keywords included in the page and counts of each keyword in said list of keywords; and
a list of URL links of the page.

55. The method of claim 54, further comprising the step of applying the steps of generating said list of potential new keywords, downloading the page and generating the three lists of keywords for each URL link in said list of URL links by said keyword generator of said data processing server.

56. The method of claim 53, wherein the step of selecting the successful keywords comprises the steps of:
performing an analysis of a relative frequency of said potential new keywords using said database comprising stored keywords and associated language and usage frequency rate of each stored keyword by said keyword generator of said data processing sever;
selecting a representative of said potential new keywords as a successful keyword by performing a two-by-two combination of said potential new keywords to find synonymous keywords by said keyword generator of said data processing server;
applying the steps performing the analysis and selecting the representative of said potential new keywords for each synonymous keyword by said keyword generator of said data processing server;
storing a list of the successful keywords in said database by said keyword generator of said data processing server; and
arranging the successful keywords for insertion into test advertising campaigns to be performed by an automatic tester of said data processing server.

57. The method of claim 46, further comprising the step of transmitting an online advertising campaign onto search engine media by approving each advertiser's campaign administrator account for each search engine medium by said data processing server, and automatically transmitting at least one advertising campaign received from an advertiser computer over a communications network to said each search engine medium by said data processing server.

58. The method of claim 46, further comprising the step of performing the generation new keywords for said existing online advertising campaign during a search engine sales campaign by said data processing server.

59. A method for generating negative keywords in an advertising campaign, comprising the steps of:
retrieving keywords of search queries made by internauts on search engines over a communications network by a negative keyword generator of a data processing server to provide a list of search query keywords;
storing said list of search query keywords in a database by said negative keyword generator of said data processing server;
comparing said list of search query keywords from search queries to a list of keywords from said existing advertising campaign by said negative keyword generator of said data processing server;
automatically generating a list of negative keywords comprising search query keywords not included in said list of keywords of said existing campaign by said negative keyword generator of said data processing server; and
storing said list of negative keywords in said database by said negative keyword generator of said data processing server.

60. The method of claim 59, further comprising the step of retrieving said search query keywords through an intermediary of search engines' application programme interfaces (APIs) over said communications network by said negative keyword generator of said data processing server.

61. The method of claim 59, wherein the step of generating said list of search query keywords comprises the steps of:
separating each search query into a list of individual keywords by said negative keyword generator of said data processing server to provide said list of search query keywords; and
storing said list of search query keywords in said database by said negative keyword generator of said data processing server.

62. The method of claim 59, wherein the step of comparing said search query keywords of a search query to said list of keywords of said existing advertising campaign comprises the steps of:
a) comparing a neighbouring search query keyword to said list of keywords of said existing advertising campaign by said negative keyword generator of said data processing server if a search query keyword of said search query is included in said list of keywords of said existing advertising campaign;
b) determining if each keyword on said list of keywords of said existing advertising campaign is contained in said search query by said negative keyword generator of said data processing server if said search query keyword is not included in said list of keywords of said existing advertising campaign;
c) adding said each keyword to said list of negative keywords by said negative keyword generator of said data processing server if it is determined said each keyword is contained in said search query; and
d) repeating the steps of a)-c) until all search query keyword of said search query is compared to said list of keywords of said existing advertising campaign.

63. The method of claim 59, further comprising the step of performing the generation of negative keywords in said advertising campaign during a search engine sales campaign by said data processing server.

64. An automatic performance testing method of a main advertising campaign, comprising the steps of:
automatically generating and storing a first new group of secondary advertisements comprising same data as said main advertising campaign in a database by an automatic tester of a data processing server to test performances of already generated advertisements for said main advertising campaign by serving as a test bench for new keywords;
automatically generating and storing a second new group of advertisements comprising the same data as said main advertising campaign in said database by said automatic tester of said data processing server to test performances of said already generated advertisements for said main advertising campaign by serving as a test bench for new publicity messages; and
automatically generating and storing a third new group of advertisements comprising the same data as said main advertising campaign in said database by said automatic tester of said data processing server to test performances of said already generated advertisements for said main advertising campaign by serving as a test bench for negative keywords.

65. The method of claim 64, further comprising the step of allocating the same data to each new group of advertisements as said main advertising campaign by said automatic tester of said data processing server; and wherein the same data being same submission price proposed for a keyword, same message, same negative keywords, and same cash price.

66. The method of claim 64, further comprising the steps of:
retrieving test results for the first, second and third new groups of advertisements from said database by said automatic tester of said data processing server;
automatically deactivating the first, second and third new groups of advertisements by said automatic tester of said data processing server after a predetermined amount data is retrieved for analysis;
analyzing the test results by said automatic tester of said data processing server to determine a most efficient group of advertisements with respect to said main advertising campaign.

67. A method for generating messages in an advertising campaign, comprising the steps of:
acquiring new messages for said advertising campaign from an advertiser computer over a communications network by an advertisement message generator of a data processing server;
determining a best message among all messages acquired by said advertisement message generator of said data processing server based on a click-through-rate (CTR) of associated advertisement;
receiving clicks data comprising a number of clicks on said associated advertisement of a web page viewed by internauts from search engine media over a communications network and storing said clicks data in said database by said advertisement message generator of said data processing server; and
receiving advertisement data comprising a number of times said associated advertisement has been delivered to said web page from said search engine media over said communications network and storing said advertisement data in said database by said advertisement message generator of said data processing server; and
wherein said CTR is obtained by said advertisement message generator of said data processing server by dividing said clicks data by said advertisement data.

68. The method of claim 67, wherein the step of determining the best message comprises the steps of:
splitting each message of said advertising campaign into sentences by said advertisement message generator of said data processing server;
automatically combining each sentence with another sentence to generate new messages by said advertisement message generator of said data processing server; and
testing the new messages to select the best messages by an automatic tester of said data processing server.

69. The method of claim 67, further comprising the steps of:
storing the best message in a message database comprising messages by an automatic tester of said data processing server;
associating each message in said message database with a series of keywords by said automatic tester of said data processing server;
comparing each message in said message database to sentences of existing messages of said advertisement campaign stored by said automatic tester of said data processing server; and
adding each sentence to the existing messages stored in said message database by said advertisement message generator of said data processing server if there is a correspondence between said each sentence and an existing message.

70. The method of claim 67, further comprising the steps of:
determining a synonyms database comprising synonyms by an automatic tester of said data processing server;
determining a slogans database comprising slogans by said automatic tester of said data processing server;
associating each slogan with a series of keywords by said automatic tester of said data processing server;
comparing said each slogan to sentences of the existing messages of said advertising campaign by said automatic tester of said data processing server;
constructing a new sentence using synonyms of said series of keywords associated with said each slogan by said advertisement message generator of said data processing server if there is a correspondence between said each slogan and the sentences of the existing messages; and
adding the new sentence to all available messages by said advertisement message generator of said data processing server.
